(19) United States
(12) Patent Application Publication
(10) Pub. No.: US 2009/0027741 A1
(43) Pub. Date: Jan. 29, 2009

(54) INITIALIZING AN IMAGE SCANNER

(76) Inventors: Kian Hong Quah, Singapore (SG); Bradley Thomas Smith, Boise, ID (US); Weilong Chen, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/829,694

(22) Filed: Jul. 27, 2007

(51) Int. Cl. H04N 1/04

(52) U.S. Cl. 358/497

(57) ABSTRACT

In a method for initializing an image scanner having a scanning module and an automatic document feed (ADF) glass, the scanning module is moved in a forward direction toward the ADF glass to search for a reference mark located within a relatively close proximity to the ADF glass. The scanning module is moved forward to search for a black-white transition in response to the reference mark being located and the scanning module is moved in a backward direction away from the ADF glass in response to the black-white transition being located. The scanning module is stopped when the image sensor of the scanning module is aligned with an origin mark to thereby accurately position the scanning module.

### BACKGROUND

Image scanners employed as standalone devices peripherally attached to personal computers and within multifunction machines have become commonplace. One type of image scanner comprises flatbed image scanners, such as the flatbed image scanner 100 having automatic document feed capability depicted in FIG. 1. FIG. 1, more particularly, depicts a simplified bottom view of a conventional flatbed image scanner 100.

The image scanner 100 in FIG. 1 is depicted as including a casing 102 that supports a flatbed glass 104 and an automatic document feed (ADF) glass 106. Also located within the casing 102 is a scanning module 1 10, which includes an image sensor 112, such as a charge-coupled device (CCD). The scanning module 110 is positioned below the flatbed glass 104 and the ADF glass 106, and is movable in the directions indicated by the arrow 114 to scan and read a document placed on the flatbed glass 104. In addition, the scanning module 110 is movable to a location beneath the ADF glass 106 to position the image sensor 112 in a position to scan and read documents as they are automatically fed over the ADF glass 106.

The image scanner 100 includes a light source that irradiates light onto documents placed on the flatbed glass 104 and the ADF glass 106, and the image sensor 112 photoelectrically converts optical images of the documents into digital images. The digital images are then transferred to a computer or, in the case of a photocopier or multifunction machine, the digital images are printed, transmitted over a network, or stored in a memory of the photocopier or multifunction machine.

As discussed above, the scanning module 110 moves back and forth to scan a document or to position the image sensor 112 beneath the ADF glass 106. Typically, a stepper motor 118, along with other components (not shown), such as, a timing belt and shaft, are employed to move the scanning module 110. The stepper motor 118 is normally designed without a sensor to detect the position of the scanning module 110. Thus, when the scanning module 110 is moved, the exact position of the scanning module 110 (and thus the image sensor 112) cannot be determined solely based upon the stepper motor 118 operation.

As such, a reference position of the scanning module 110 must be checked for each movement of the scanning module 110 whenever the flatbed image scanner 100 is initialized. More particularly, the flatbed image scanner 100 typically performs an initialization process to determine the exact position of the scanning module 110. In the initialization process, the image sensor 112 is employed to scan and capture a series of patterns representing an origin mark 120 that has been molded into the casing 102 or other sections of the flatbed image scanner 100 as the scanning module 110 is moved with respect to the flatbed glass 104. In addition, pattern matching algorithms are employed to compare the captured series of patterns with various stored patterns to determine when the scanning module 110 is accurately positioned beneath the origin mark 120.

As shown in FIG. 1, the origin mark 120 in some conventional flatbed image scanners 100 having ADF capabilities is positioned relatively far away from the ADF glass 106. In addition, the scanning module 110 may be positioned anywhere under the flatbed glass 104 at a given time prior to implementing the initialization process. Due to structural limits, the image sensor 112 could be located at a position X 130. As such, regardless of the starting position of the image sensor 112, the scanning module 110 is moved 240 steps, where each step is 1/300^{th} of an inch, towards the ADF glass 106. When the image sensor 112 is initially at position X 130, this backtracking movement places the image sensor 112 over a position Y 132. This process is called “static backtracking”.

The scanning module 110 is then gradually moved so that the image sensor 112 is positioned over position Z 134 to locate a black-white transition 140. Thereafter, the scanning module 110 is moved such that a reference mark 150 is identified with the image sensor 112. Moreover, the scanning module 110 is moved such that the image sensor 112 is positioned accurately under the origin mark 120.

However, when the image scanner 100 shuts down, during almost all normal operations, the flatbed image scanner 100 enters into an idle mode where the image sensor 112 is placed near the origin mark 120. As such, during the initialization process, because of the static backtracking process discussed above, the scanning module 110 will position the image sensor 112 at an initial position 136, which is relatively far away from the origin mark 120. In other words, the scanning module 110 is moved 240 steps from a starting position during the backtracking process. The initialization process performed by conventional flatbed image scanners 100 is therefore relatively long and often extends the amount of time it takes for the flatbed image scanners 100 to boot up, thereby causing the amount of time for a first document to be scanned to be relatively long.

It would therefore be beneficial to have an initialization process that substantially reduces the amount of time required to accurately position an image sensor under an origin mark.

### BRIEF DESCRIPTION OF THE DRAWINGS

Features of the present invention will become apparent to those skilled in the art from the following description with reference to the figures, in which:

FIG. 1 shows a simplified schematic diagram from a bottom view of a conventional flatbed image scanner;

FIG. 2 shows a simplified schematic diagram from a bottom view of an image scanner configured to implement various embodiments of the invention, according to an embodiment of the invention;

FIG. 3 shows a simplified block diagram of an image scanner configured to implement various embodiments of the invention, according to an embodiment of the invention; and

FIG. 4 shows a flow diagram of a method for initializing an image scanner, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are a method and system for initializing an image scanner in which the amount of time required to perform the initialization is substantially reduced as compared with conventional scanners. In addition, the initialization operation disclosed herein enables the image scanner to be initialized without the use of positional sensor or prior knowledge of a scanning module location in the image scanner. As such, the initialization operation disclosed herein is relatively simple and cost-effective to implement, while providing improved results over conventional initialization operations.

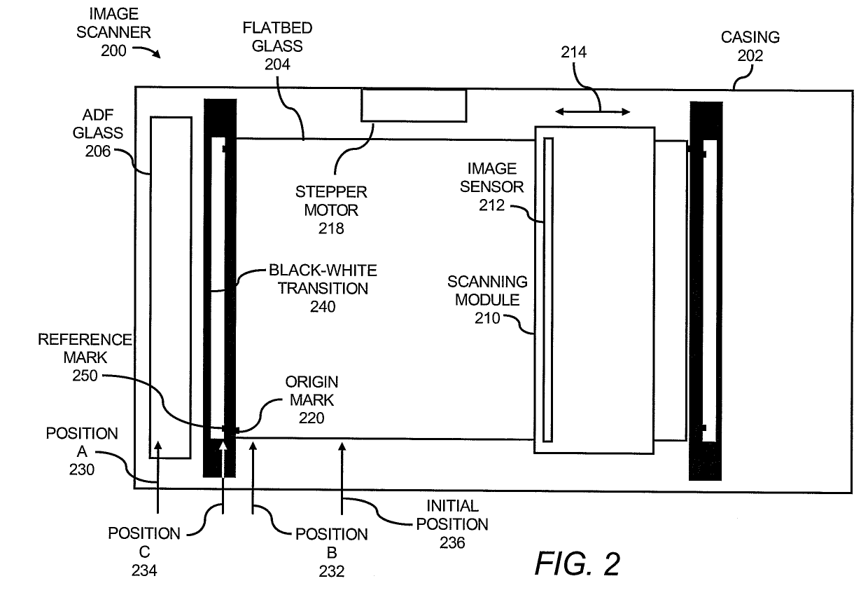

With reference first to FIG. 2, there is shown a simplified schematic diagram from a bottom view of an image scanner 200 configured to implement various embodiments of the invention, according to an example. It should be understood that the image scanner 200 may include additional components and that some of the components described herein may be removed and/or modified without departing from a scope of the image scanner 200. For instance, the image scanner 200 may include a light source for enhancing the capture of images.

The image scanner 200 generally comprises an apparatus configured to capture images of documents and to convert the captured images into digital signals that may be interpreted by a computer system. As such, the image scanner 200 may comprise a standalone computer system peripheral apparatus, part of a multifunction machine, etc.

As shown in FIG. 2, the image scanner 200 includes a casing 202 that supports a flatbed glass 204 and an automatic document feed (ADF) glass 206. Positioned below the flatbed glass 204 and the ADF glass 206 is a scanning module 210. The scanning module 210 includes an image sensor 212, such as a charge-coupled device (CCD), for capturing images of documents placed on the flatbed glass 204 or fed over the ADF glass 206.

When a document is placed on the flatbed glass 204, the scanning module 210 is configured to move back and forth as indicated by the arrow 214. In addition, the image sensor 212 is activated to capture images of the documents as the scanning module 210 is moved. When one or more documents are fed over the ADF glass 206 by an automatic document feeder (not shown), the scanning module 210 is moved to a position that accurately places the image sensor 212 beneath the ADF glass 206 and in position to capture images of the documents as they are fed over the ADF glass 206.

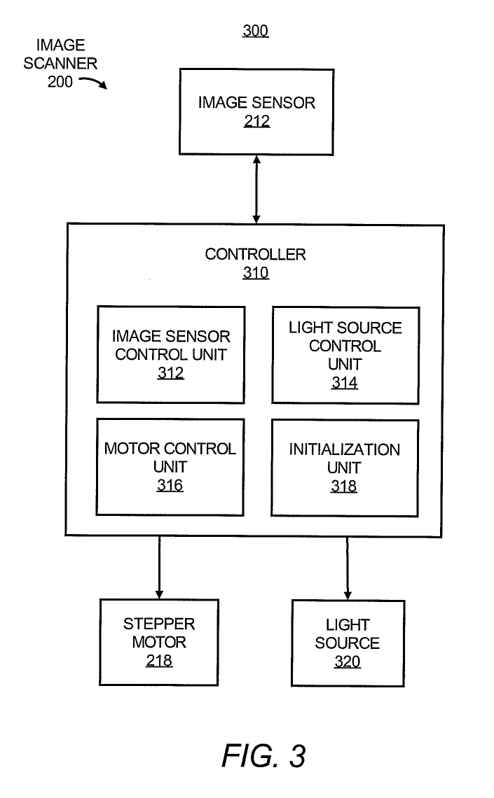

In either of the instances discussed above, the scanning module 210 is moved by a stepper motor 218. Although not shown, the scanning module 210 and the stepper motor 218 may be connected to a timing belt and a rod such that rotation of the stepper motor 218 causes the scanning module 210 to be moved linearly with respect to the casing 202. The stepper motor 218 may be attached to the scanning module 210 and configured to move the scanning module 210 in any reasonably suitable known manner. In addition, the stepper motor 218 may be operated by a controller 310 (FIG. 3) of the image scanner 200 as described below.

The stepper motor 218 is typically designed without a sensor to detect the position of the scanning module 210. Thus, when the scanning module 210 is moved, the exact position of the image sensor 212 may not be determined solely based upon operations of the stepper motor 218. In order to determine the exact position of the image sensor 212 and therefore capture accurate reproductions of documents, the image scanner 200 is configured to operate the stepper motor 218 in various manners discussed in greater detail herein below to initialize the image scanner 200 during a startup process and thereby position the image sensor 212 at a known starting location.

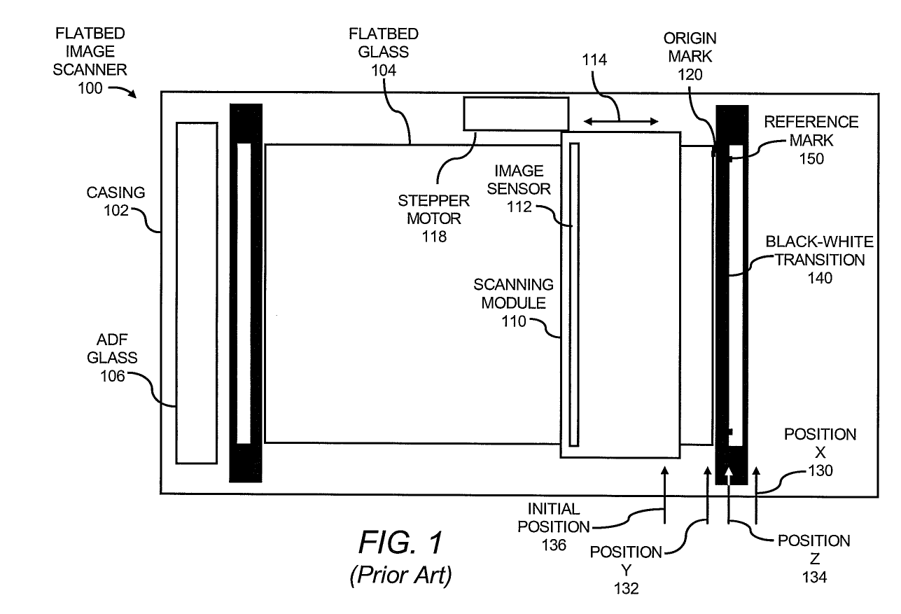

The initialization operation is performed using a plurality of identifications formed or placed in the casing 202. More particularly, for instance, the initialization operation is performed by identifying when the scanning module 210 is beneath an origin mark 220, a black-white transition 240, and a reference mark 250, as described in greater detail herein below. Initially, however, in contrast to the conventional image scanner 100 depicted in FIG. 1, the origin mark 220, the black-white transition 240, and the reference mark 250 depicted in FIG. 2 are located in relatively close proximity to the ADF glass 206. The relatively close proximity of these identifications generally enables an initialization operation to be performed on the image scanner 200 in a shorter amount of time as compared with conventional initiation operations.

With reference now to FIG. 3, there is shown a simplified block diagram 300 of an image scanner 200 configured to perform various embodiments of the invention, according to an example. It should be understood that the image scanner 200 may include additional components and that some of the components described herein may be removed and/or modified without departing from a scope of the image scanner 200.

As shown in FIG. 3, the image scanner 200 includes a controller 310, which may comprise a computing device, for instance, a microprocessor, a micro-controller, an application specific integrated circuit (ASIC), or the like, configured to perform various processing functions. The controller 310 is also depicted as having a plurality of units 312-318 for performing some of these processing functions. The units 312-318 may comprise hardware, software, firmware, or combinations thereof that the controller 310 may invoke or implement.

More particularly, the controller 310 includes an image sensor control unit 312, a light source control unit, an initialization unit 316, and a motor control unit 318. The controller 310 is configured to invoke or implement the image sensor control unit 312 to communicate with and control the image sensor 212. More particularly, the controller 310 is configured to invoke or implement the image sensor control unit 312 to activate and deactivate the image sensor 212. The controller 310 is also configured to invoke or implement the image sensor control unit 312 to receive digital signals of the images captured by the image sensor 212. The controller 310 may store the digital signals in a memory (not shown) or may communicate the digital signals over a network or other connection.

The controller 310 is configured to invoke or implement the light source control unit 314 to control a light source 320 of the image scanner 200. The controller 310 may activate the light source 320, for instance, immediately prior to activation of the image sensor 212 to thereby substantially enhance the capture of images by the image sensor 212.

The controller 310 is configured to invoke or implement the motor control unit 316 to control operations of the stepper motor 218 and thereby vary the position of the scanning module 210 and the image sensor 212.

The controller 310 is configured to invoke or implement the initialization unit 318 to perform an initialization operation when the image scanner 200 undergoes a startup process. In invoking or implementing the initialization unit 318, the controller 310 is configured to also invoke the image sensor control unit 312, the light source control unit 314, and the motor control unit 316, as described in greater detail herein below.

Although not shown, in the instance that the units 312-318 comprise software, the units 312-318 may comprise software modules stored in a memory, such as DRAM, EEPROM, MRAM, flash memory, and the like, that the controller 310 may access in performing one or more of the functions described above.

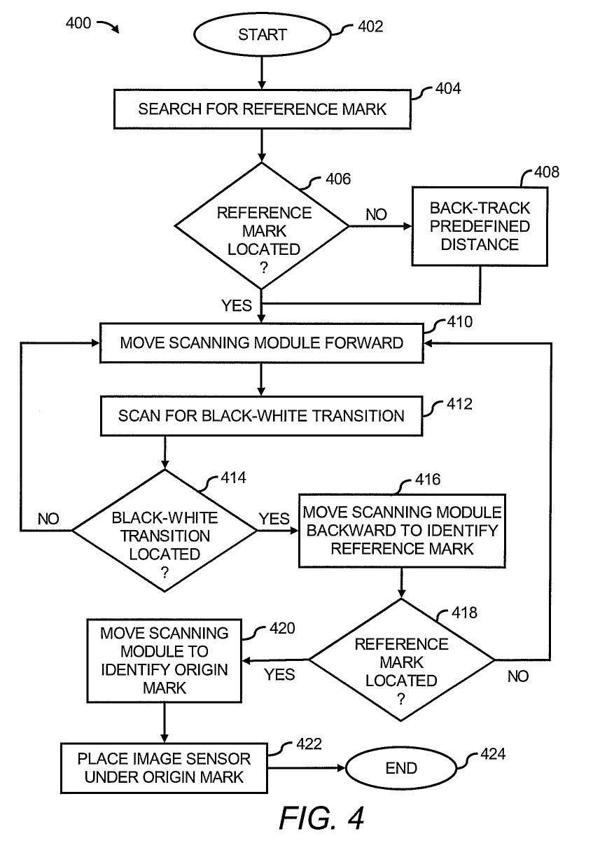

Turning now to FIG. 4, there is shown a flow diagram of a method 400 for initializing an image scanner 200, according to an example. It should be apparent to those of ordinary skill in the art that the method 400 represents a generalized illustration and that other steps may be added or existing steps may be removed, modified or rearranged without departing from a scope of the method 400.

The description of the method 400 is made with reference to the image scanner 200 illustrated in FIGS. 2 and 3, and thus makes reference to the elements cited therein. It should, however, be understood that the method 400 is not limited to the elements set forth in the image scanner 200. Instead, it should be understood that the method 200 may be practiced by an image scanner having a different configuration than that set forth in FIGS. 2 and 3.

Generally speaking, the controller 310 may implement the method 400 to initialize the image scanner 200 during a startup process, for instance, when the image scanner 200 is activated from an “off” state or from a “standby” condition. More particularly, the controller 310 may implement the method 400 to substantially decrease the amount of time for an image scanner 200 initialization operation as compared with conventional initialization operations.

Part of the reduced initialization operation time is realized through placement of the origin mark 220, the black-white transition 240, and the reference mark 250 in relatively close proximity to the ADF glass 206, as shown in FIG. 2. In one regard, by performing the initialization operation described in the method 400, the scanning module 210 may more quickly be positioned to scan documents fed over the ADF glass 206.

At step 402, the controller 310 invokes or implements the initialization unit 310 to start the method 400. As discussed above, the controller 310 may start the method 400 when the image scanner 200 is turned on, activated from a stand-by condition, etc.

Once initiated, the controller 310 searches for the reference mark 250. More particularly, the controller 310 searches for the reference mark 250 by invoking or implementing the motor control unit 316 to activate the stepper motor 218 to rotate and cause the scanning module 210 to move in a direction toward the ADF glass 206, which is considered the forward direction. As the scanning module 210 is moved toward the ADF glass 206, the controller 310 invokes or implements the image sensor control unit 312 to capture images. The controller 310 also invokes or implements the light source control unit 314 to activate the light source 320 to thereby irradiate light that enhances capture of the images.

The controller 310 processes the captured images to determine whether the image sensor 212 is positioned beneath the reference mark 250. The controller 310 makes this determination, for instance, by performing a pattern matching operation between the captured images and a stored image of the reference mark 250. More particularly, the controller 310 determines that the image sensor 202 is positioned beneath the reference mark 250 when patterns contained in a captured image substantially match the stored pattern of the reference mark 250.

At step 406, the controller 310 determines whether the reference mark 250 has been located as indicated above. If the controller 310 determines that the reference mark 250 has not been located, the controller 310 may determine that the scanning module 210 is located at or near position A 230, which depicts the worst-case scenario of the image sensor 212 starting position. In this regard, the controller 310 may operate the motor 218 to back-track for a predefined distance at step 408.

The predefined distance may be equal to a distance slightly greater than a distance between a maximum forward position (position A 230) and the origin mark 220. In other words, the predefined distance may be slightly longer than the distance between the position A 230 and the position B 232. The controller 310 may control movement of the scanning module 210 to be equivalent to the predefined distance by controlling the number of steps the stepper motor 218 takes at step 408. As a particular example, the predefined number of steps may comprise about 720 steps of the stepper motor 218.

Thus, at step 408, the scanning module 210 may be moved away from the ADF glass 206 for the predefined number of steps to position B 232, which is considered the rearward direction. For purposes of comparison, in conventional initialization processes, the scanning module 210 is moved backwards to an initial position 236 which is beyond position B 232 prior to moving toward position C 234. As such, the method 400 reduces the amount of time required in initializing the image scanner 200 as compared with conventional techniques because the scanning module 210 is moved a shorter distance to account for the worst-case scenario.

Following either of steps 406 and 408, the controller 310 controls the stepper motor 218 to move the scanning module 210 forward toward position C 234 (in the direction of the ADF glass 206) for a few steps, as indicated at step 410. As the controller 310 moves the scanning module 210 forward, the controller 310 again activates the image sensor 212 to scan for the black-white transition 240, at step 412. The controller 310 is configured to perform a pattern matching operation on the captured images and a stored image of the black-white transition 240 to determine when the image sensor 212 is positioned beneath the black-white transition 240.

If the controller 310 determines that the black-white transition 240 has not been located at step 414, the controller 310 may activate the stepper motor 218 to continue to move the scanning module 210 forward at step 410 and may continue scanning for the black-white transition 240 at steps 410 and 412 until the controller 310 determines that the image sensor 212 is positioned beneath the black-white transition 240 at step 414.

At step 416, the controller 310 controls the stepper motor 218 to move the scanning module 210 backwards to locate the reference mark 250. At step 418, the controller 310 determines whether the reference mark 250 has been located. If the controller 310 determines that the reference mark 250 has not been located, the controller 310 may control the stepper motor 218 to move the scanning module 210 forward again at step 410, and steps 412-418 may be repeated until the reference mark 250 is located at step 418.

Following step 418, the controller 310 controls the stepper motor 218 to move the scanning module 210 to locate an origin mark 220, at step 420. The controller 310 may identify the reference mark 250 and the origin mark 220 through use of the pattern matching process discussed above.

At step 422, the controller 310 places the image sensor 212 accurately under the origin mark 220. Once placed, the controller 310 may end the method 400, as indicated at step 424, and the image scanner 200 may be ready to scan its first document.

Through implementation of the method 400, the amount of time required to calibrate an image scanner at startup is substantially reduced in comparison with conventional calibration techniques. As such, the amount of time a user must wait for the first image to be scanned may be substantially reduced in comparison with conventional initialization processes.

In addition, the method 400 does not require that the positional information of the scanning module 210 be stored prior to the image scanner 200 shutting down because the positional information is dynamically generated during performance of the method 400. As such, in comparison with conventional calibration processes, the controller 310 does not need to spend extra time and computational resources to store the positional information prior to shutting down nor does the controller 310 need to spend extra time and computational resources in retrieving the positional information during startup. Moreover, the initialization process contained in the method 400 enables the image scanner 200 to be operated even when the image scanner 200 experiences an abnormal or faulty state because of the dynamic generation of the scanning module 210 positional information.

The operations set forth in the method 400 may be contained as a utility, program, or subprogram, in any desired computer accessible medium. In addition, the method 200 may be embodied by a computer program, which can exist in a variety of forms both active and inactive. For example, it can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. A method for initializing an image scanner having a scanning module and an automatic document feed (ADF) glass, said scanning module housing an image sensor, said method comprising:
(a) moving the scanning module in a forward direction toward the ADF glass to search for a reference mark, wherein the reference mark is located within a relatively close proximity to the ADF glass;
(b) moving the scanning module forward to search for a black-white transition in response to the reference mark being located;
(c) moving the scanning module in a backward direction away from the ADF glass in response to the black-white transition being located; and
(d) stopping the scanning module movement when the image sensor is aligned with an origin mark to thereby accurately position the scanning module.

2. The method according to claim 1, further comprising:
capturing images with the image sensor as the scanning module is moved in the forward direction to search for the reference mark; and
processing the captured images to determine whether the reference mark has been located.

3. The method according to claim 2, wherein processing the captured images further comprises comparing the captured images with a stored image of the reference mark to determine whether a match has been identified.

4. The method according to claim 1, further comprising:
capturing images with the image sensor as the scanning module is moved forward to search for the black-white transition; and
processing the captured images to determine whether the black-white transition has been located.

5. The method according to claim 4, wherein processing the captured images further comprises comparing the captured images with a stored image of the black-white transition to determine whether a match has been identified.

6. The method according to claim 1, further comprising:
in response to the reference mark not being located during the step of moving the scanning module in the forward direction, moving the scanning module in a rearward direction away from the ADF glass for a predefined distance, wherein the predefined distance is equal to a distance slightly greater than a distance between a maximum forward position of the scanning module and the origin mark; and
following movement of the scanning module in the rearward direction for the predefined distance, moving the scanning module forward to search for the black-white transition.

7. The method according to claim 6, wherein moving the scanning module in the rearward direction for a predefined distance further comprises activating a stepper motor to cause the scanning module to move the predefined distance.

8. The method according to claim 1, further comprising
performing steps (a)-(d) during a startup process of the image scanner.

9. The method according to claim 1, further comprising:
performing steps (a)-(d) without prior data regarding a position of the scanning module with respect to the reference mark.

10. An image scanner comprising:
an automatic document feed (ADF) glass;
a scanning module housing an image sensor;
a motor configured to the scanning module with respect to the ADF glass;
a reference mark, a black-white transition, and an origin mark; and
a controller configured to perform an initialization operation, wherein during the initialization operation, the controller is configured to operate the motor to move the scanning module toward the automatic document feed glass and to operate the image sensor to continuously capture images as the scanning module is moved, to locate the reference mark from the captured images, to operate the motor to move the scanning module toward the ADF glass until a black-white transition is located, and to operate the motor to move the scanning module under an origin mark after the black-white transition has been located.

11. The image scanner according to claim 10, wherein the controller is further configured to control the motor to move the scanning module in a direction away from the ADF glass for a predefined distance in response to the reference mark not being located, wherein the predefined distance is equal to a distance slightly greater than a distance between a maximum forward position of the scanning module and the origin mark.

12. The image scanner according to claim 10, wherein the controller is further configured to compare the images captured by the image sensor with stored images of the reference mark and the black-white transition to locate the reference mark and the black-white transition through a pattern matching operation.

13. The image scanner according to claim 10, wherein the reference mark, the black-white transition, and the origin mark are positioned in relatively close proximity to the ADF glass.

14. The image scanner according to claim 10, wherein the image scanner further comprises a flatbed glass.

15. The image scanner according to claim 10, wherein the motor comprises a stepper motor that does not include a sensor configured to detect a position of the scanning module.

16. The image scanner according to claim 10, wherein the controller is further configured to perform the initialization operation during a startup process of the image scanner.

17. The image scanner according to claim 10, wherein the controller is further configured to perform the initialization operation without prior data regarding a position of the scanning module with respect to the reference mark.

18. A computer readable storage medium on which is embedded one or more computer programs, said one or more computer programs implementing a method for initializing an image scanner having a scanning module and an automatic document feed (ADF) glass, and wherein the scanning module houses an image sensor, said one or more computer programs comprising computer readable code for:
during a startup process of the image scanner,
(a) moving the scanning module in a forward direction toward the ADF glass to search for a reference mark, wherein the reference mark is located within a relatively close proximity to the ADF glass;
(b) moving the scanning module forward to search for a black-white transition in response to the reference mark being located;
(c) moving the scanning module in a backward direction away from the ADF glass in response to the black-white transition being located; and
(d) stopping the scanning module movement when the image sensor is aligned with an origin mark to thereby accurately position the scanning module.

19. The computer readable storage medium according to claim 18, said one or more computer programs further comprising computer readable code for:
capturing images with the image sensor and comparing patterns contained in the captured images with patterns in previously stored images of the reference mark and the black-white transition; and
locating the reference mark and the black-white transition based upon matching the patterns.

20. The computer readable storage medium according to claim 18, said one or more computer programs further comprising computer readable code for:
in response to the reference mark not being located during the step of moving the scanning module in the forward direction, moving the scanning module in a rearward direction away from the ADF glass for a predefined distance, wherein the predefined distance is equal to a distance slightly greater than a distance between a maximum forward position of the scanning module and the origin mark; and
following movement of the scanning module in the rearward direction for the predefined distance, moving the scanning module forward to search for the black-white transition.
